(19) United States
(12) Patent Application Publication
(10) Pub. No.: US 2017/0355135 A1
(43) Pub. Date: Dec. 14, 2017

(54) FEEDBACK CONTROL SYSTEM FOR PRINTING 3D PARTS

(71) Applicant: Eastman Kodak Company, Rochester, NY (US)

(72) Inventor: Thomas Nathaniel Tombs, Rochester, NY (US)

(21) Appl. No.: 15/177,730

(22) Filed: Jun. 9, 2016

(51) Int. Cl. B29C 64/153; B29C 64/188; G03G 15/00; B33Y 50/02; B33Y 10/00; B33Y 30/00; B29C 64/35; B29C 64/393

(52) U.S. Cl. CPC B29C 64/153; B29C 64/35; B29C 64/188; B29C 64/393; B33Y 50/02; B33Y 10/00; B33Y 30/00; G03G 15/00

(57) ABSTRACT

An electrophotography-based additive manufacturing system is used to print a three-dimensional part. An electrophotography engine is used to print a part layer of the three-dimensional part is using a part material compositionally including part material particles. The developed part layer is transferred from the electrophotography engine to a transfer medium, and the transferred part layer is transfused together to previously-printed layers using a layer transfusion assembly. A surface height profile of the transfused part layers is measured using a surface profilometer, and a thickness profile of a subsequently-printed part layer is controlled responsive to the measured surface height profile.

### CROSS-REFERENCE TO RELATED APPLICATIONS

Reference is made to commonly assigned, co-pending U.S. Patent Application Ser. No. 62/286,490, entitled: “Large format electrophotographic 3D printer,” by C. Sreekumar et al.; and to commonly assigned, co-pending U.S. patent application Ser. No. 15/091,789, entitled: “Printing 3D parts with controlled surface finish,” by T. Tombs et al., each which is incorporated herein by reference.

### FIELD OF THE INVENTION

This invention pertains to the field of additive manufacturing systems for printing three-dimensional parts and support structures, and more particularly to a feedback control system for accurately printing three-dimensional parts with precise dimensions and accurately replicated features.

### BACKGROUND OF THE INVENTION

Additive manufacturing systems are used to build three-dimensional (3D) parts from digital representations of the 3D parts using one or more additive manufacturing techniques. Common forms of such digital representations would include the well-known AMF and STL file formats. Examples of commercially available additive manufacturing techniques include extrusion-based techniques, ink jetting, selective laser sintering, powder/binder jetting, electron-beam melting, and stereolithographic processes. For each of these techniques, the digital representation of the 3D part is initially sliced into a plurality of horizontal layers. For each sliced layer, a tool path is then generated, that provides instructions for the particular additive manufacturing system to form the given layer.

For example, in an extrusion-based additive manufacturing system, a 3D part (sometimes referred to as a 3D model) can be printed from the digital representation of the 3D part in a layer-by-layer manner by extruding a flowable part material. The part material is extruded through an extrusion tip carried by a printhead of the system, and is deposited as a sequence of layers on a substrate in an x-y plane. The extruded part material fuses to previously deposited part material, and solidifies upon a drop in temperature. The position of the printhead relative to the substrate is then incremented along a z-axis (perpendicular to the x-y plane), and the process is then repeated to form a 3D part resembling the digital representation.

In fabricating 3D parts by depositing layers of a part material, supporting layers or structures are typically built underneath overhanging portions or in cavities of objects under construction, which are not supported by the part material itself. A support structure may be built utilizing the same deposition techniques by which the part material is deposited. The host computer generates additional geometry defining the support structure for the overhanging or free-space segments of the 3D part being formed, and in some cases, for the sidewalls of the 3D part being formed. The support material adheres to the part material during fabrication, and is removable from the completed 3D part when the printing process is complete.

In two-dimensional (2D) printing, electrophotography (also known as xerography) is a technology for creating 2D images on planar substrates, such as printing paper and transparent substrates. Electrophotography systems typically include a conductive support drum coated with a photoconductive material layer, where latent electrostatic images are formed by electrostatic charging, followed by image-wise exposure of the photoconductive layer by an optical source. The latent electrostatic images are then moved to a developing station where toner is applied to charged areas, or alternatively to discharged areas of the photoconductive insulator to form visible images. The formed toner images are then transferred to substrates (e.g., printing paper) and affixed to the substrates with heat and/or pressure.

U.S. Pat. No. 9,144,940 (Martin), entitled “Method for printing 3D parts and support structures with electrophotography-based additive manufacturing,” describes an electrophotography-based additive manufacturing method that is able to make a 3D part using a support material and a part material. The support material compositionally includes a first charge control agent and a first copolymer having aromatic groups, (meth)acrylate-based ester groups, carboxylic acid groups, and anhydride groups. The part material compositionally includes a second charge control agent, and a second copolymer having acrylonitrile units, butadiene units, and aromatic units.

The method described by Martin includes developing a support layer of the support structure from the support material with a first electrophotography engine, and transferring the developed support layer from the first electrophotography engine to a transfer medium. The method further includes developing a part layer of the 3D part from the part material with a second electrophotography engine, and transferring the developed part layer from the second electrophotography engine to the transfer medium. The developed part and support layers are then moved to a layer transfusion assembly with the transfer medium, where they are transfused together to previously-printed layers.

It is difficult to make an accurate reproduction of a three-dimensional part by transferring hundreds or thousands of toner layers one at a time to a platen when using only the spatial information of the desired end product is used. Small changes or drift in the registration of the layers caused by changes in temperature, slip in conveyance elements, vibration, drive variability or other disturbances create errors in the dimensions of the printed object. Electrophotographic interactions between subsystems often cause periodic and artifacts such as spots, bands and streaks in the printed layers. Non-periodic artifacts are also difficult to avoid in electrophotography. Hence, there is a need for a method to improve the accurate reproduction of the precise dimensions and features when printing a three-dimensional object using electrophotography, and to eliminate print artifacts associated with the electrophotographic process.

### SUMMARY OF THE INVENTION

The present invention represents a method for printing a three-dimensional part and with an electrophotography-based additive manufacturing system, the method including:

providing a part material compositionally including part material particles;

developing a part layer of the three-dimensional part from the part material with a first electrophotography engine;

transferring the developed part layer from the first electrophotography engine to a transfer medium;

transfusing the transferred part layer together to previously-printed layers using a layer transfusion assembly;

measuring a surface height profile of the transfused part layers using a surface profilometer; and

controlling a thickness profile of a subsequently-printed part layer responsive to the measured surface height profile.

This invention has the advantage that print artifacts, misregistration and other errors caused by the printing process are compensated for so that the printed 3D part is a precise replica of the digital information describing the desired object to be printed.

It has the further advantage that part yield is improved, thereby reducing the cost to print 3D parts.

### BRIEF DESCRIPTION OF THE DRAWINGS

FIG. 1 is a schematic front view of an exemplary electrophotography-based additive manufacturing system for printing 3D parts and support structures from part and support materials;

FIG. 2 is a schematic front view showing additional details of the electrophotography engines in the additive manufacturing system of FIG. 1;

FIG. 3 is a schematic front view showing an alternative electrophotography engine, which includes an intermediary drum or belt;

FIG. 4 is a schematic front view illustrating a layer transfusion assembly for performing layer transfusion steps;

FIG. 5 is a flowchart showing a method for constructing a 3D part and support structure in accordance with an exemplary embodiment; and

FIG. 6 is a schematic front view illustrating a layer transfusion assembly for performing layer transfusion steps including a surface profilometer for measuring surface height profiles in accordance with the present invention.

It is to be understood that the attached drawings are for purposes of illustrating the concepts of the invention and may not be to scale. Identical reference numerals have been used, where possible, to designate identical features that are common to the figures.

### DETAILED DESCRIPTION OF THE INVENTION

The invention is inclusive of combinations of the embodiments described herein. References to “a particular embodiment” and the like refer to features that are present in at least one embodiment of the invention. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to the “method” or “methods” and the like is not limiting. It should be noted that, unless otherwise explicitly noted or required by context, the word “or” is used in this disclosure in a non-exclusive sense.

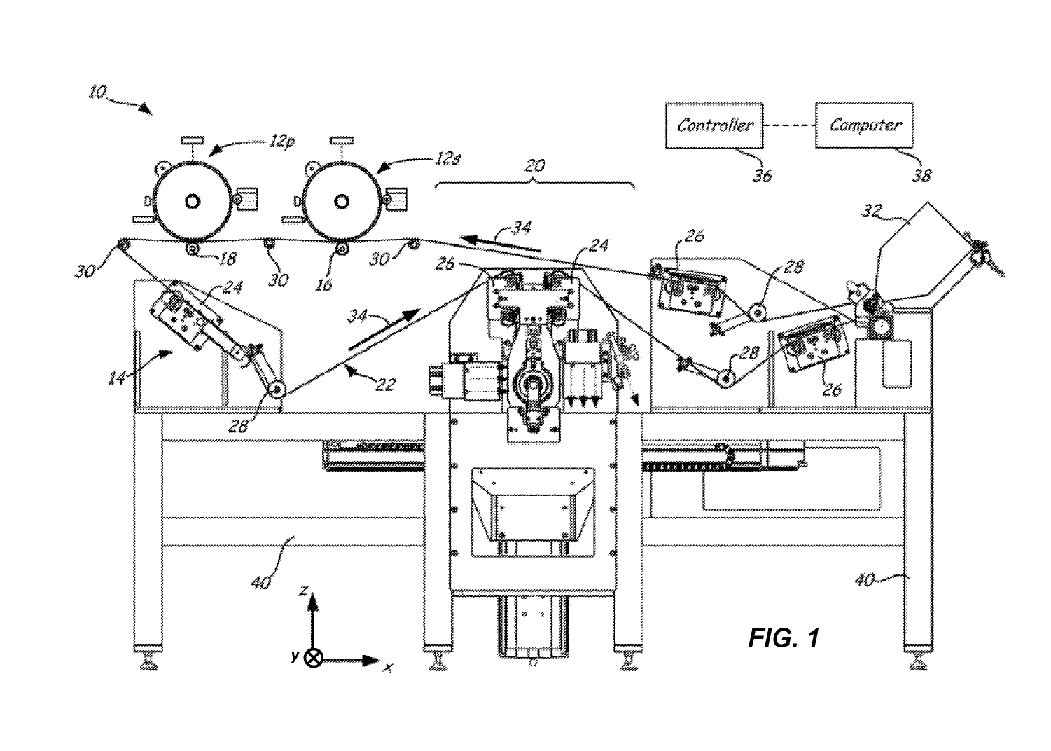

FIGS. 1-4 illustrate an exemplary additive manufacturing system 10, which uses an electrophotography-based additive manufacturing process for printing 3D parts from a part material (e.g., an ABS part material), and associated support structures from a removable support material. As shown in FIG. 1, additive manufacturing system 10 includes a pair of electrophotography (EP) engines 12p and 12s, belt transfer assembly 14, biasing mechanisms 16 and 18, and layer transfusion assembly 20.

Examples of suitable components and functional operations for additive manufacturing system 10 include those disclosed in U.S. Patent Application Publication No. 2013/0077996 (Hanson et al.), entitled “Electrophotography-based additive manufacturing system with reciprocating operation;” in U.S. Patent Application Publication No. 2013/0077997 (Hanson et al.), entitled “Electrophotography-based additive manufacturing system with transfer-medium service loop;” in U.S. Patent Application Publication No. 2013/0186549 (Comb et al.), entitled “Layer transfusion for additive manufacturing;” and in U.S. Patent Application Publication No. 2013/0186558 (Comb et al.), entitled “Layer transfusion with heat capacitor belt for additive manufacturing,” each of which is incorporated herein by reference.

EP engines 12p and 12s are imaging engines for respectively imaging or otherwise developing layers of the part and support materials, where the part and support materials are each preferably engineered for use with the particular architecture of EP engine 12p and 12s. The part material compositionally includes part material particles, and the support compositionally includes support material particles. In an exemplary embodiment, the support material compositionally includes support material particles including a first charge control agent and a first copolymer having aromatic groups, (meth)acrylate-based ester groups, carboxylic acid groups, and anhydride groups; and the part material compositionally includes part material particles including a second charge control agent, and a second copolymer having acrylonitrile units, butadiene units, and aromatic units. As discussed below, the developed part and support layers are transferred to belt transfer assembly 14 (or some other appropriate transfer medium) with biasing mechanisms 16 and 18, and carried to the layer transfusion assembly 20 to produce the 3D parts and associated support structures in a layer-by-layer manner.

In the illustrated configuration, belt transfer assembly 14 includes transfer belt 22, which serves as the transfer medium, belt drive mechanisms 24, belt drag mechanisms 26, loop limit sensors 28, idler rollers 30, and belt cleaner 32, which are configured to maintain tension on the transfer belt 22 while transfer belt 22 rotates in rotational direction 34. In particular, the belt drive mechanisms 24 engage and drive the transfer belt 22, and the belt drag mechanisms 26 function as brakes to provide a service loop design for protecting the transfer belt 22 against tension stress, based on monitored readings from the loop limit sensors 28.

Additive manufacturing system 10 also includes a controller 36, which includes one or more control circuits, microprocessor-based engine control systems, or digitally-controlled raster imaging processor systems, and which is configured to operate the components of additive manufacturing system 10 in a synchronized manner based on printing instructions received from a host computer 38. Host computer 38 includes one or more computer-based systems configured to communicate with controller 36 to provide the print instructions (and other operating information). For example, host computer 38 can transfer information to controller 36 that relates to the individual layers of the 3D parts and support structures, thereby enabling additive manufacturing system 10 to print the 3D parts and support structures in a layer-by-layer manner.

The components of additive manufacturing system 10 are typically retained by one or more frame structures, such as frame 40. Additionally, the components of additive manufacturing system 10 are preferably retained within an enclosable housing (not shown) that prevents ambient light from being transmitted to the components of additive manufacturing system 10 during operation.

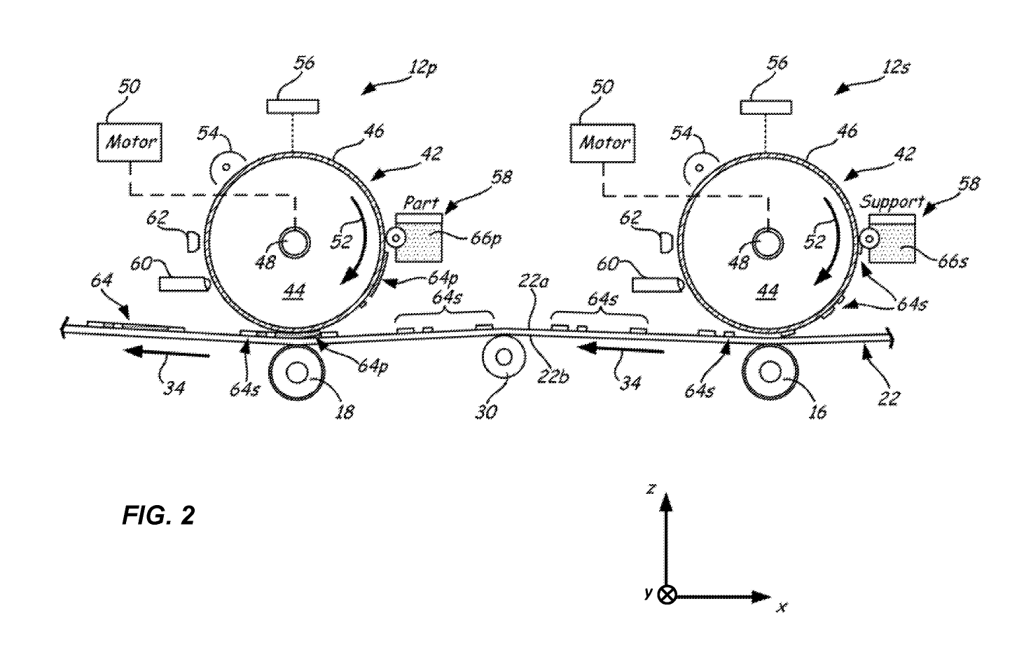

FIG. 2 illustrates EP engines 12p and 12s in additional detail. EP engine 12s (i.e., the upstream EP engine relative to the rotational direction 34 of transfer belt 22) develops layers of support material 66s, and EP engine 12p (i.e., the downstream EP engine relative to the rotational direction 34 of transfer belt 22) develops layers of part material 66p. In alternative configurations, the arrangement of EP engines 12p and 12s can be reversed such that EP engine 12p is upstream from EP engine 12s relative to the rotational direction 34 of transfer belt 22. In other alternative configuration, additive manufacturing system 10 can include one or more additional EP engines for printing layers of additional materials.

In the illustrated configuration, EP engines 12p and 12s utilize identical components, including photoconductor drums 42, each having a conductive drum body 44 and a photoconductive surface 46. Conductive drum body 44 is an electrically-conductive drum (e.g., fabricated from copper, aluminum, tin, or the like) that is electrically grounded and configured to rotate around shaft 48. Shaft 48 is correspondingly connected to drive motor 50, which is configured to rotate the shaft 48 (and the photoconductor drum 42) in rotation direction 52 at a constant rate.

Photoconductive surface 46 is a thin film extending around the circumferential surface of conductive drum body 44, and is preferably derived from one or more photoconductive materials, such as amorphous silicon, selenium, zinc oxide, organic materials, and the like. As discussed below, photoconductive surface 46 is configured to receive latent-charged images of the sliced layers of a 3D part or support structure (or negative images), and to attract charged particles of the part or support material of the present disclosure to the charged (or discharged image areas), thereby creating the layers of the 3D part and support structures.

As further shown, EP engines 12p and 12s also include charging device 54, imager 56, development station 58, cleaning station 60, and discharge device 62, each of which is in signal communication with controller 36. Charging device 54, imager 56, development station 58, cleaning station 60, and discharge device 62 accordingly define an image-forming assembly for surface 46 while drive motor 50 and shaft 48 rotate photoconductor drum 42 in the rotation direction 52.

In the illustrated example, the image-forming assembly for photoconductive surface 46 of EP engine 12s is used to form support material layers 64s of support material 66s, where a supply of support material 66s is retained by development station 58 of EP engine 12s, along with associated carrier particles. Similarly, the image-forming assembly for photoconductive surface 46 of EP engine 12p is used to form part material layers 64p of part material part material 66p, where a supply of part material 66p is retained by development station 58 of EP engine 12p, along with associated carrier particles. Charging device 54 is configured to provide a uniform electrostatic charge on the photoconductive surface 46 as the photoconductive surface 46 rotates in the rotation direction 52 past the charging device 54. Suitable devices that can be used for the charging device 54 include corotrons, scorotrons, charging rollers, and other electrostatic devices.

Imager 56 is a digitally-controlled, pixel-wise light exposure apparatus configured to selectively emit electromagnetic radiation toward the uniform electrostatic charge on the photoconductive surface 46 as the photoconductive surface 46 rotates in the rotation direction 52 past the imager 56. The selective exposure of the electromagnetic radiation on the photoconductive surface 46 is controlled by the controller 36, and causes discrete pixel-wise locations of the electrostatic charge to be removed (i.e., discharged to ground), thereby forming latent image charge patterns on the photoconductive surface 46. The imager 56 in the EP engine 12p is controlled to provide a latent image charge pattern in accordance with a specified pattern for a particular part material layer 64p, and the imager 56 in the EP engine 12s is controlled to provide a latent image charge pattern in accordance with a specified pattern for a corresponding support material layer 64s.

Suitable devices for imager 56 include scanning laser light sources (e.g., gas or solid state lasers), light emitting diode (LED) array exposure devices, and other exposure device conventionally used in 2D electrophotography systems. In alternative embodiments, suitable devices for charging device 54 and imager 56 include ion-deposition systems configured to selectively deposit charged ions or electrons directly to the photoconductive surface 46 to form the latent image charge pattern. As such, as used herein, the term “electrophotography” includes “ionography.”

Each development station 58 is an electrostatic and magnetic development station or cartridge that retains the supply of part material 66p or support material 66s, preferably in powder form, along with associated carrier particles. The development stations 58 typically function in a similar manner to single or dual component development systems and toner cartridges used in 2D electrophotography systems. For example, each development station 58 can include an enclosure for retaining the part material 66p or support material 66s and carrier particles. When agitated, the carrier particles generate triboelectric charges to attract the part material particles of the part material 66p or the support material particles of the support material 66s, which charges the attracted particles to a desired sign and magnitude, as discussed below.

Each development station 58 typically include one or more devices for transferring the charged part material 66p or support material 66s to the photoconductive surface 46, such as conveyors, fur brushes, paddle wheels, rollers or magnetic brushes. For instance, as the photoconductive surface 46 (having the latent image charge pattern) rotates past the development station 58 in the rotation direction 52, the particles of charged part material 66p or support material 66s are attracted to the appropriately charged regions of the latent image on the photoconductive surface 46, utilizing either charged area development or discharged area development (depending on the electrophotography mode being utilized). This creates successive part material layers 64p and support material layers 64s as the photoconductor drum 42 continues to rotate in the rotation direction 52, where the successive part material layers 64p and support material layers 64s correspond to the successive sliced layers of the digital representation of the 3D part and support structures.

The successive part material layers 64p and support material layers 64s are then rotated with photoconductive surfaces 46 in the rotation direction 52 to a transfer region in which the part material layers 64p and support material layers 64s are successively transferred from the photoconductor drums 42 to the transfer belt 22, as discussed below. While illustrated as a direct engagement between photoconductor drum 42 and transfer belt 22, in some preferred embodiments, EP engines 12p and 12s may also include intermediary transfer drums or belts, as discussed further below. The EP engines 12p and 12s are configured so that the part material layers 64p are transferred onto the transfer belt in registration with the corresponding support material layers 64s to provide combined layers 64.

After a given part material layer 64p or support material layer 64s is transferred from the photoconductor drum 42 to the transfer belt 22 (or an intermediary transfer drum or belt), drive motor 50 and shaft 48 continue to rotate the photoconductor drum 42 in the rotation direction 52 such that the region of the photoconductive surface 46 that previously held the developed layer passes the cleaning station 60. The cleaning station 60 is configured to remove any residual, non-transferred portions of part material 66p or support material 66s from the photoconductive surface 46. Suitable types of cleaning devices for use in the cleaning station 60 include blade cleaners, brush cleaners, electrostatic cleaners, vacuum-based cleaners, and combinations thereof.

After passing the cleaning station 60, the photoconductive surface 46 continues to rotate in the rotation direction 52 such that the cleaned regions of the photoconductive surface 46 pass by the discharge device 62 to remove any residual electrostatic charge on photoconductive surface 46 prior to starting the next cycle. Suitable types of discharge devices 62 include optical systems, high-voltage alternating-current corotrons and/or scorotrons, one or more rotating dielectric rollers having conductive cores with applied high-voltage alternating-current, and combinations thereof.

The transfer belt 22 is a transfer medium for transporting the developed part material layers 64p and support material layers 64s from photoconductor drum 42 (or an intermediary transfer drum or belt) to the layer transfusion assembly 20 (FIG. 1). Examples of suitable types of transfer belts 22 include those disclosed in Comb et al. in the aforementioned U.S. Patent Application Publication No. 2013/0186549 and U.S. Patent Application Publication No. 2013/0186558 by Comb et al. The transfer belt 22 includes a front surface 22a and a rear surface 22b, where the front surface 22a faces the photoconductive surfaces 46 of photoconductor drums 42 and the rear surface 22b is in contact with biasing mechanisms 16 and 18.

Biasing mechanisms 16 and 18 are configured to induce electrical potentials through transfer belt 22 to electrostatically attract the part material layers 64p and support material layers 64s from EP engines 12p and 12s, respectively, to the transfer belt 22. Because the part material layers 64p and support material layers 64s each represent only a single layer increment in thickness at this point in the process, electrostatic attraction is suitable for transferring the part material layers 64p and support material layers 64s from the EP engines 12p and 12s to the transfer belt 22.

Preferably, the controller 36 rotates the photoconductor drums 42 of EP engines 12p and 12s at the same rotational rates, such that the tangential velocity of the photoconductive surfaces 46 are synchronized with the line speed of the transfer belt 22 (as well as with any intermediary transfer drums or belts). This allows the additive manufacturing system 10 to develop and transfer the part material layers 64p and support material layers 64s in coordination with each other from separate developed images. In particular, as shown, each part material layer 64p is transferred to transfer belt 22 in proper registration with each support material layer 64s to produce the combined layer 64. As discussed below, this allows the part material layers 64p and support material layers 64s to be transfused together. To enable this, the part material 66p and support material 66s preferably have thermal properties and melt rheologies that are the same or substantially similar. Within the context of the present invention, “substantially similar thermal properties and melt rheologies” should be interpreted to be within 20% of regularly measured properties such as glass transition temperature, melting point and melt viscosity. As can be appreciated, some combined layers 64 transported to layer transfusion assembly 20 may only include support material 66s or may only include part material 66p, depending on the particular support structure and 3D part geometries and layer slicing.

In an alternative and generally less-preferred configuration, part material layers 64p and support material layers 64s may optionally be developed and transferred along transfer belt 22 separately, such as with alternating part material layers 64p and support material layers 64s. These successive, alternating layers 64p and 64s may then be transported to layer transfusion assembly 20, where they may be transfused separately to print the 3D part and support structure.

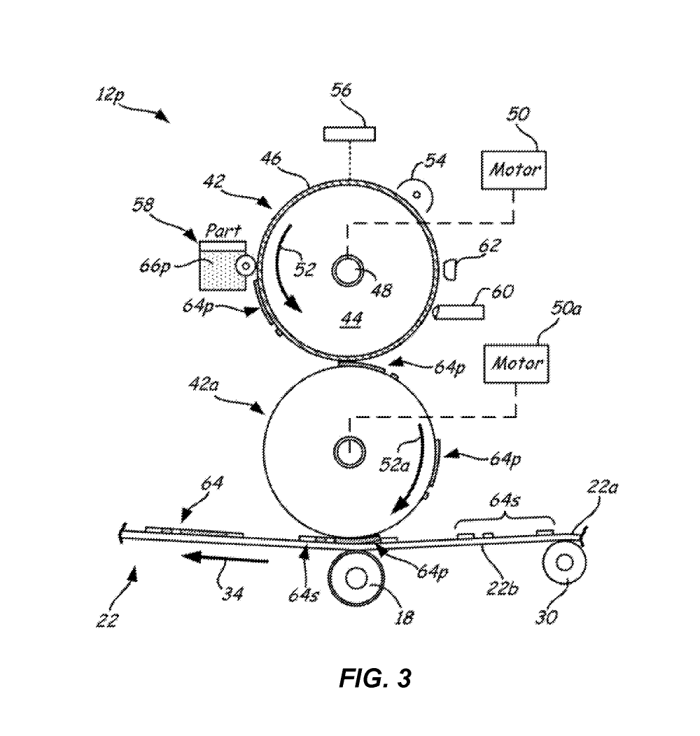

In some configurations, one or both of EP engines 12p and 12s can also include one or more intermediary transfer drums or belts between the photoconductor drum 42 and the transfer belt 22. For example, FIG. 3 illustrates an alternate configuration for an EP engine 12p that also includes an intermediary drum 42a. The intermediary drum 42a rotates in a rotation direction 52a opposite to the rotation direction 52, under the rotational power of drive motor 50a. Intermediary drum 42a engages with photoconductor drum 42 to receive the developed part material layers 64p from the photoconductor drum 42, and then carries the received part material layers 64p and transfers them to the transfer belt 22.

In some configurations, the EP engine 12s (FIG. 2) can use a same arrangement using an intermediary drum 42a for carrying the developed support material layers 64s from the photoconductor drum 42 to the transfer belt 22. The use of such intermediary transfer drums or belts for EP engines 12p and 12s can be beneficial for thermally isolating the photoconductor drum 42 from the transfer belt 22, if desired.

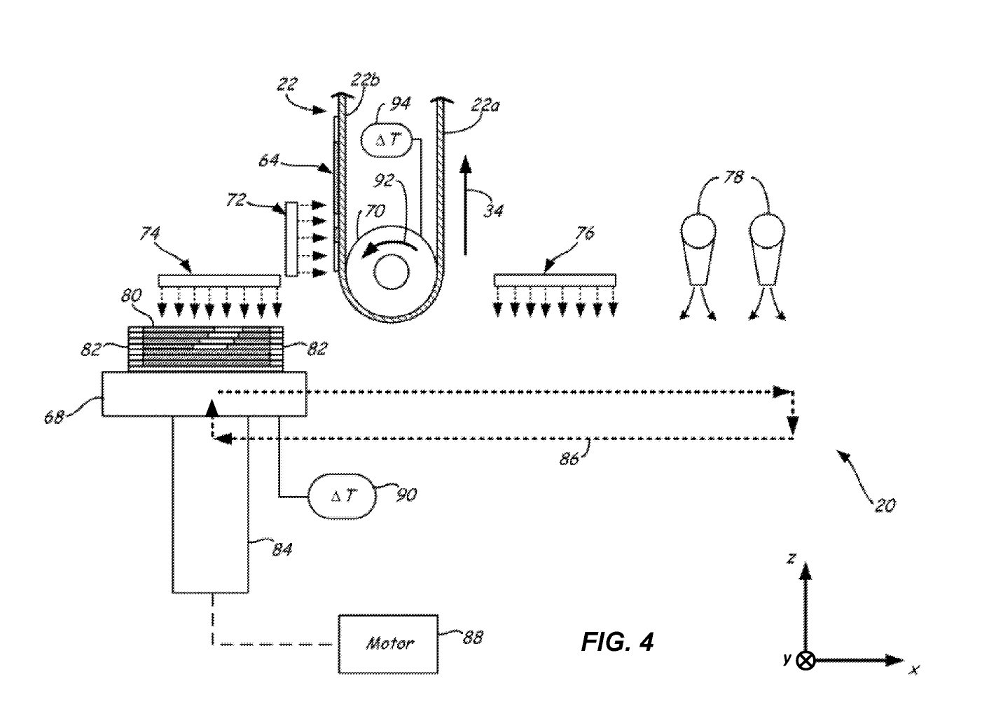

FIG. 4 illustrates an exemplary configuration for the layer transfusion assembly 20. In the illustrated embodiment, the layer transfusion assembly uses a heating process to fuse the combined layer 64 to the previously printed layers of the 3D part 80 and support structure 82. In other embodiments, the layer transfusion assembly 20 can use other types of transfusion processes to perform the fusing operation. For example, a solvent process can be used to soften the part material 66p and the support material 66s so that they can be fused to the previously printed layers of the 3D part 80 and support structure 82 by pressing them together.

As shown, the layer transfusion assembly 20 includes build platform 68, nip roller 70, heaters 72 and 74, post-fuse heater 76, and air jets 78 (or other cooling units). Build platform 68 is a platform assembly or platen that is configured to receive the heated combined layers 64 (or separate part material layers 64p and support material layers 64s) for printing a 3D part 80 and support structure 82, in a layer-by-layer manner. In some configurations, the build platform 68 may include removable film substrates (not shown) for receiving the combined layers 64, where the removable film substrates may be restrained against build platform using any suitable technique (e.g., vacuum drawing, removable adhesive, mechanical fastener, and the like).

The build platform 68 is supported by gantry 84, which is a gantry mechanism configured to move build platform 68 along the z-axis and the x-axis in a reciprocating rectangular motion pattern 86, where the primary motion is back-and-forth along the x-axis. Gantry 84 may be operated by a motor 88 based on commands from the controller 36, where the motor 88 can be an electrical motor, a hydraulic system, a pneumatic system, or the like.

In the illustrated configuration, the build platform 68 is heatable with heating element 90 (e.g., an electric heater). Heating element 90 is configured to heat and maintain the build platform 68 at an elevated temperature that is greater than room temperature (e.g., about 25° C.), such as at a desired average part temperature of 3D part 80 and support structure 82, as discussed by Comb et al. in the aforementioned U.S. Patent Application Publication No. 2013/0186549 and U.S. Patent Application Publication No. 2013/0186558. This allows build platform 68 to assist in maintaining the 3D part 80 and support structure 82 at the desired average part temperature.

Nip roller 70 is a heatable element or a heatable layer transfusion element, which is configured to rotate around a fixed axis with the movement of transfer belt 22. In particular, nip roller 70 may roll against the rear surface 22b in rotation direction 92 while the transfer belt 22 rotates in the rotation direction 34. In the illustrated configuration, nip roller 70 is heatable with heating element 94 (e.g., an electric heater). Heating element 94 is configured to heat and maintain nip roller 70 at an elevated temperature that is greater than the room temperature (e.g., 25° C.), such as at a desired transfer temperature for combined layers 64.

Heater 72 includes one or more heating device (e.g., an infrared heater or a heated air jet) configured to heat the combined layers 64 to a temperature near an intended transfer temperature of the part material 66p and support material 66s, such as at least a fusion temperature of the part material 66p and support material 66s, preferably prior to reaching nip roller 70. Each combined layer 64 preferably passes by (or through) heater 72 for a sufficient residence time to heat the combined layer 64 to the intended transfer temperature. Heater 74 may function in the same manner as heater 72, and heats the top surfaces of 3D part 80 and support structure 82 to an elevated temperature, such as at the same transfer temperature as the heated combined layers 64 (or other suitable elevated temperature).

As mentioned above, the support material 66s used to print support structure 82 preferably has thermal properties (e.g., glass transition temperature) and a melt rheology that are similar to or substantially the same as the thermal properties and the melt rheology of the part material 66p used to print 3D part 80. This enables the part material 66p of the part material layer 64p and the support material 66s of the support material layer 64s to be heated together with heater 74 to substantially the same transfer temperature, and also enables the part material 66p and support material 66s at the top surfaces of 3D part 80 and support structure 82 to be heated together with heater 74 to substantially the same temperature. Thus, the part material layers 64p and the support material layers 64s can be transfused together to the top surfaces of 3D part 80 and support structure 82 in a single transfusion step as combined layer 64. This single transfusion step for transfusing the combined layer 64 is typically impractical without sufficiently matching the thermal properties and the melt rheologies of the part material 66p and support material 66s.

Post-fuse heater 76 is located downstream from nip roller 70 and upstream from air jets 78, and is configured to heat the transfused layers to an elevated temperature to perform a post-fuse or heat-setting operation. Again, the similar thermal properties and melt rheologies of the part and support materials enable the post-fuse heater 76 to post-heat the top surfaces of 3D part 80 and support structure 82 together in a single post-fuse step.

Prior to printing 3D part 80 and support structure 82, build platform 68 and nip roller 70 may be heated to their desired temperatures. For example, build platform 68 may be heated to the average part temperature of 3D part 80 and support structure 82 (due to the similar melt rheologies of the part and support materials). In comparison, nip roller 70 may be heated to a desired transfer temperature for combined layers 64 (also due to the similar thermal properties and melt rheologies of the part and support materials).

During the printing operation, transfer belt 22 carries a combined layer 64 past heater 72, which may heat the combined layer 64 and the associated region of transfer belt 22 to the transfer temperature. Suitable transfer temperatures for the part and support materials include temperatures that exceed the glass transition temperatures of the part material 66p and the support material 66s, which are preferably similar or substantially the same, and where the part material 66p and support material 66s of combined layer 64 are softened but not melted (e.g., to a temperature ranging from about 140° C. to about 180° C. for an ABS part material).

As further shown in the exemplary configuration of FIG. 4, during operation, gantry 84 moves the build platform 68 (with 3D part 80 and support structure 82) in a reciprocating rectangular motion pattern 86. In particular, the gantry 84 moves build platform 68 along the x-axis below, along, or through heater 74. Heater 74 heats the top surfaces of the 3D part 80 and support structure 82 to an elevated temperature, such as the transfer temperatures of the part and support materials. As discussed by Comb et al. in the aforementioned U.S. Patent Application Publication No. 2013/0186549 and U.S. Patent Application Publication No. 2013/0186558, heaters 72 and 74 can heat the combined layers 64 and the top surfaces of the 3D part 80 and support structure 82 to about the same temperatures to provide a consistent transfusion interface temperature. Alternatively, heaters 72 and 74 can heat the combined layers 64 and the top surfaces of the 3D part 80 and support structure 82 to different temperatures to attain a desired transfusion interface temperature.

The continued rotation of transfer belt 22 and the movement of build platform 68 align the heated combined layer 64 with the heated top surfaces of the 3D part 80 and support structure 82 with proper registration along the x-axis. The gantry 84 continues to move the build platform 68 along the x-axis at a rate that is synchronized with the tangential velocity of the transfer belt 22 (i.e., the same directions and speed). This causes rear surface 22b of the transfer belt 22 to rotate around nip roller 70 and brings the heated combined layer 64 into contact with the top surfaces of 3D part 80 and support structure 82. This presses the heated combined layer 64 between the front surface 22a of the transfer belt 22 and the heated top surfaces of 3D part 80 and support structure 82 at the location of nip roller 70, which at least partially transfuses the heated combined layer 64 to the top layers of 3D part 80 and support structure 82.

As the transfused combined layer 64 passes the nip of nip roller 70, the transfer belt 22 wraps around nip roller 70 to separate and disengage the transfer belt from the build platform 68. This assists in releasing the transfused combined layer 64 from the transfer belt 22, enabling the transfused combined layer 64 to remain adhered to the 3D part 80 and the support structure 82, thereby adding a new layer to the 3D part and the support structure 82. Maintaining the transfusion interface temperature at a transfer temperature that is higher than the glass transition temperatures of the part and support materials, but lower than their fusion temperatures, enables the heated combined layer 64 to be hot enough to adhere to 3D part 80 and support structure 82, while also being cool enough to readily release from transfer belt 22. Additionally, as discussed earlier, the similar thermal properties and melt rheologies of the part and support materials allow them to be transfused in the same step.

After release, the gantry 84 continues to move the build platform 68 along the x-axis to the post-fuse heater 76. At the post-fuse heater 76, the top-most layers of 3D part 80 and support structure 82 (including the transfused combined layer 64) are preferably heated to at least the fusion temperature of the part and support materials in a post-fuse or heat-setting step. This melts the part and support materials of the transfused layer 64 to a highly fusible state such that polymer molecules of the transfused layer 64 quickly inter-diffuse to achieve a high level of interfacial entanglement with the 3D part 80 and the support structure 82.

The gantry 84 continues to move the build platform 68 along the x-axis past post-fuse heater 76 to air jets 78, the air jets 78 blow cooling air towards the top layers of 3D part 80 and support structure 82. This actively cools the transfused layer 64 down to the average part temperature, as discussed by Comb et al. in the aforementioned U.S. Patent Application Publication No. 2013/0186549 and U.S. Patent Application Publication No. 2013/0186558.

To assist in keeping 3D part 80 and support structure 82 at the desired average part temperature, in some arrangements, one or both of the heater 74 and post-heater 76 can be configured to operate to heat only the top-most layers of 3D part 80 and support structure 82. For example, in embodiments in which heaters 72, 74, and 76 are configured to emit infrared radiation, 3D part 80 and support structure 82 can include heat absorbers or other colorants configured to restrict penetration of the infrared wavelengths to within only the top-most layers. Alternatively, heaters 72, 74, and 76 can be configured to blow heated air across the top surfaces of 3D part 80 and support structure 82. In either case, limiting the thermal penetration into 3D part 80 and support structure 82 allows the top-most layers to be sufficiently transfused, while also reducing the amount of cooling required to keep 3D part 80 and support structure 82 at the desired average part temperature.

The EP engines 12p and 12s have an associated maximum printable area. For example, the EP engines in the NexPress SX3900 have a maximum printing width in the cross-track direction (i.e., the y-direction) of about 340 mm, and a maximum printing length in the in-track direction (i.e., the x-direction) of about 904 mm. When building a 3D part 80 and support structure 82 having a footprint that is smaller than the maximum printable area of the EP engines 12p and 12s, the gantry 84 next actuates the build platform 68 downward, and moves the build platform 68 back along the x-direction following the reciprocating rectangular motion pattern 86 to an appropriate starting position in the x-direction in proper registration for transfusing the next combined layer 64. In some embodiments, the gantry 84 may also actuate the build platform 68 with the 3D part 80 and support structure 82 upward to bring it into proper registration in the z-direction for transfusing the next combined layer 64. (Generally the upward movement will be smaller than the downward movement to account for the thickness of the previously printed layer.) The same process is then repeated for each layer of 3D part 80 and support structure 82.

In prior art arrangements, the size of the 3D parts 80 that could be fabricated was limited by the maximum printable area of the EP engines 12p and 12s. It would be very costly to develop specially designed EP engines 12p and 12s having maximum printable areas that are larger than those used in typical printing systems. Commonly assigned, co-pending U.S. Patent Application No. 62/286,490, entitled “Large format electrophotographic 3D printer,” which is incorporated herein by reference, describes methods for using EP engines to produce large parts by printing into a plurality of tile regions on a large build platform.

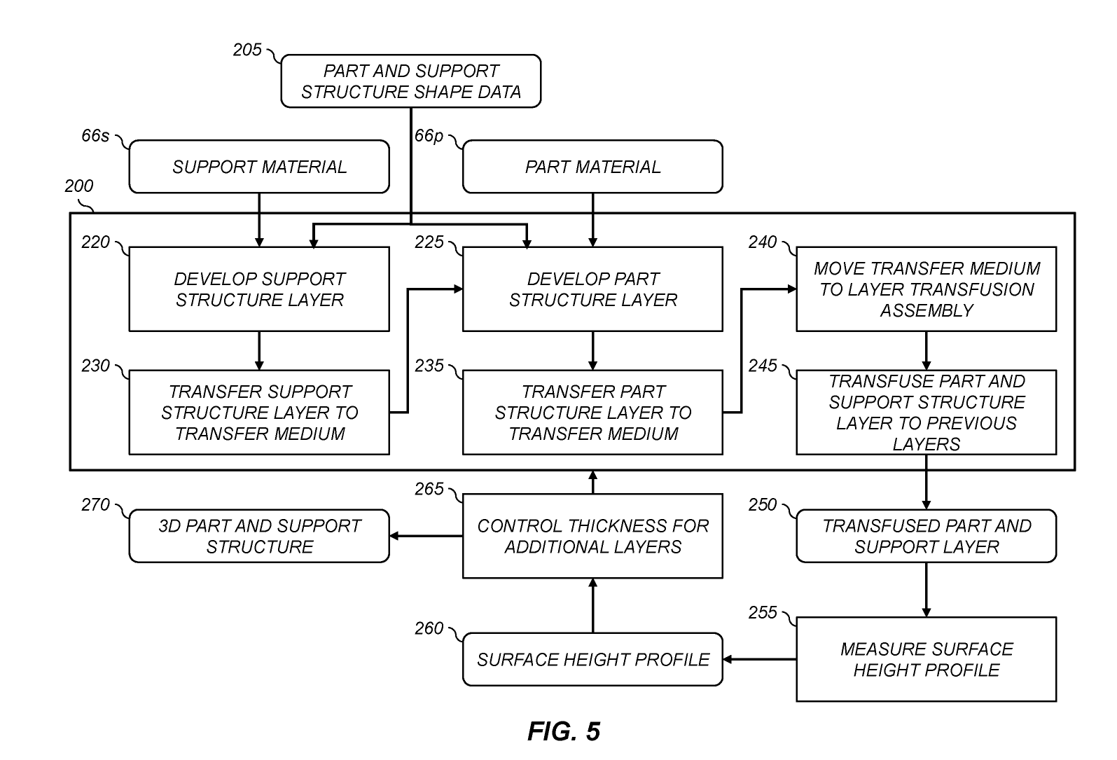

FIG. 5 shows a flow chart summarizing a method for constructing a 3D part and support structure 270 from a support material 66s and a part material 66p using an additive manufacturing system 10, such as that shown in FIG. 1, in accordance with the present invention. The part to be constructed is specified using part and support structure shape data 205, which is a digital representation specifying the desired shape of the 3D part and support structure 270. Common forms of such digital representations would include the well-known AMF and STL file formats.

The 3D part and support structure 270 is formed in a layer-by-layer manner using a layer formation process 200. A develop support structure layer step 220 is used to develop a support material layer 64s (FIG. 2) of the support structure 82 (FIG. 4) from the support material 66s (FIG. 2) using a first EP engine 12s (FIG. 2). The developed support material layer 64s is transferred from the first EP engine 12s to a transfer belt 22 (FIG. 2), or some other appropriate transfer medium, using a transfer support structure layer to transfer medium step 230. Similarly, a develop part structure layer step 225 is used to develop a part material layer 64p (FIG. 2) of the 3D part 80 (FIG. 4) from the part material 66p (FIG. 2) corresponding to the content to be constructed using a second EP engine 12p (FIG. 2). The developed part material layer 64p is then transferred from the second EP engine 12p to the transfer belt 22 using a transfer part structure layer to transfer medium step 235. As discussed earlier, the developed part material layer 64p is preferably transferred to the transfer belt 22 in registration with the developed support material layer 64s to form a combined layer 64 (FIG. 2).

A move transfer medium to layer transfusion assembly step 240 is then used to move the transfer medium (e.g., transfer belt 22) bearing the developed part material layer 64p and developed support material layer 64s to a layer transfusion assembly 20 (FIG. 4). The transfer belt 22 is aligned with an appropriate starting position of the build platform 68 of the layer transfusion assembly 20. A transfuse part and support structure layer to previous layers step 245 is then used to transfuse the developed part material layer 64p and developed support material layer 64s, adding a layer to the 3D part 80 and support structure 82, providing a transfused part and support layer 250.

In some embodiments, a tiling method can be used to form a 3D part and support structure 270 having a larger footprint than the EP engines 12s, 12p can provide. For example, the method described in commonly assigned, co-pending U.S. Patent Application Ser. No. 62/286,490, entitled: “Large format electrophotographic 3D printer,” by C. Sreekumar et al., which is incorporated herein by reference, can be used to form large format 3D parts.

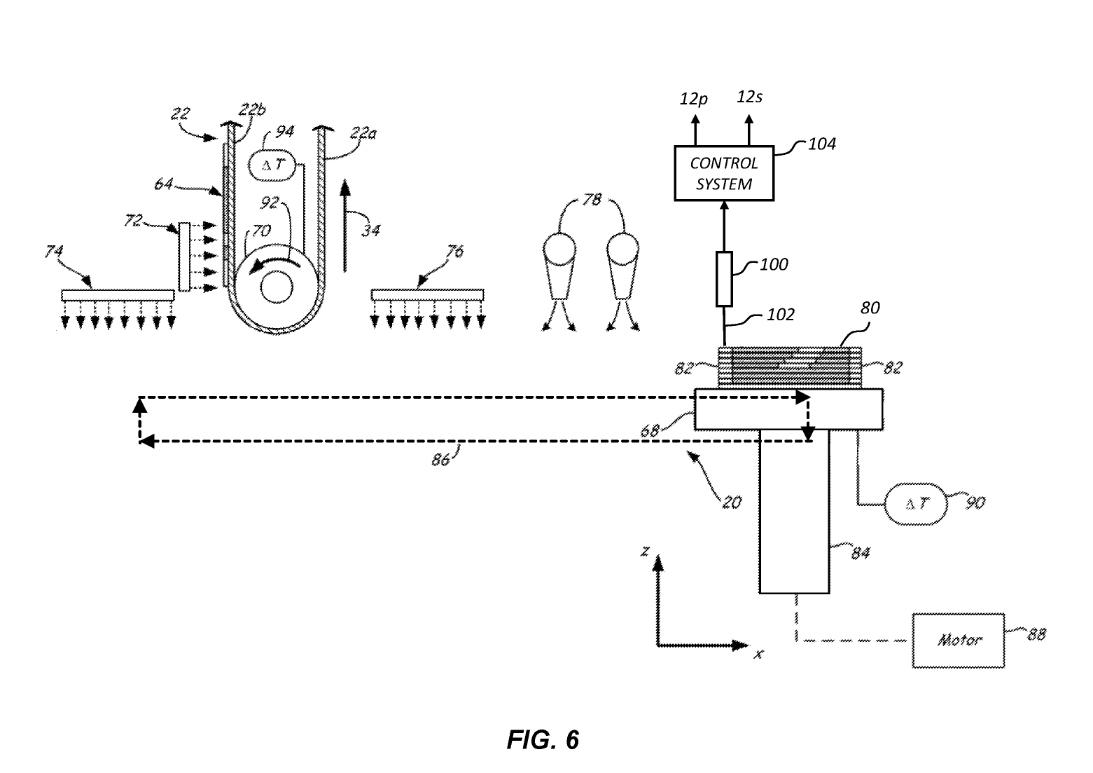

A measure surface height profile step 255 is then used to measure a surface height profile 260 of the transfused layers of the 3D part 80 and support structure 82. In an exemplary embodiment, the measure surface height profile step 255 measures the surface height profile 260 using a surface profilometer 100 as shown in FIG. 6. Within the context of the present disclosure, a surface height profile can include one or more surface height measurements that characterize the height of the surface of the transfused layers of the 3D part 80 and support structure 82. In some embodiments, the surface height profile can be a point measurement of the surface height at a particular position. In other embodiments, the surface height profile can include a plurality of surface height measurements taken at a set of different positions, which can vary in one or both of the x- and y-directions.

Any type of surface profilometer 100 known in the art can be used in accordance with the present invention. In the illustrated configuration, the surface profilometer is positioned to measure the surface profile after the current layer has been transfused onto the build platform 68, but before the build platform returns to the start position. However, it will be obvious to one skilled in the art that the surface profilometer 100 can be positioned in a variety of locations.

Surface profilometers 100 can generally be categorized as either contact or non-contact devices. For contact devices, a physical probe 102 contacts the surface of the transfused layers of the 3D part 80 and support structure 82, and the surface height is determined by providing an electrical signal representing the displacement of the probe 102. There are many ways that surface profilometer 100 can measure the displacement of the probe 102, including the use of capacitive, inductive or resistive elements. In an exemplary embodiment, the surface profilometer 100 uses a linear variable differential transformer (LVDT), such as those available from Measurement Specialties of Hampton, Va. Further information about the operation of such devices can be found in the Application Note “The LVDT: construction and principle of operation” available from the Measurement Specialties web site. An LVDT is an absolute displacement transducer that converts a linear displacement into a proportional electrical signal containing phase (for direction) and amplitude information (for distance). The LVDT operation does not require electrical contact between the moving part (probe 102) and the transformer (which is a type of inductive element), but rather relies on electromagnetic coupling.

For non-contact devices, the probe 102 is not a mechanical element that physically touches the surface of the transfused layers of the 3D part 80 and support structure 82, but rather senses the surface position by directing a beam of some sort (e.g., electromagnetic or acoustic) onto the surface and detecting a reflected beam. In such cases, the beam serves as the probe 102.

One type of non-contact device that can be used for the profilometer 100 is an optical device. In such devices, a radiation-emitting element (e.g., a laser) is used to direct a beam of radiation onto the surface of the transfused layers of the 3D part 80 and support structure 82. A detector is then used to sense the surface height based on detecting radiation reflected from the surface. In some optical profilometer devices, the beam of radiation is directed onto the surface at an angle relative to the surface normal. The detector captures an image of the surface and determines a spatial position of the reflected beam. The surface height can then be determined based on the well-known parallax effect. In other optical sensing devices, the surface height can be determined using interference effects or other optical sensing methods. In some embodiments, the LJ-G series High-accuracy 2D Laser Displacement Sensor available from the Keyence Corporation of Itasca, Ill. can be used to provide 2D surface height profiles.

Another type of non-contact device that can be used for the profilometer is an ultrasonic sensing device. Ultrasonic sensing devices typically direct an ultrasonic beam in the form of a short burst of ultrasonic sound waves toward the surface. When the sound is reflected, it returns to the sensor as an echo. The distance between the ultrasonic sensor and the target is calculated from the signal's return time and the propagation velocity of the measurement medium. In some embodiments, the M30M1 Series Ultrasonic Sensors available from the Balluff, Inc. of Florence, Ky. can be used to provide surface height profiles.

In some configurations, the surface profilometer 100 can use a 2D surface height sensor that directly provides a 2D surface height profile of the surface of the transfused layers of the 3D part 80 and support structure 82. In other configurations, the surface profilometer 100 can use a 1D surface height sensor that provides a 1D surface height profile or one or more point surface height sensors that determine a surface height profile at a single point. In such cases, 2D surface height profiles can be determined by measuring surface heights as the build platform 68 moves the surface of the transfused layers of the 3D part 80 and support structure 82 past the surface profilometer 100, or as the surface profilometer 100 is moved past the surface of the transfused layers of the 3D part 80 and support structure 82. In one exemplary configuration, a plurality of point surface height sensors are positioned at different locations across the width (i.e., the y-direction) of the build platform 68, and 1D surface height profiles are determined at each location as the build platform 68 moves the surface of the transfused layers of the 3D part 80 and support structure 82 past the point sensors in the x-direction. This effectively provides a 2D surface height profile. In this case, the resolution of the surface height profile in the cross-track y-direction will be defined by the number of point surface height sensors, and therefore may be lower than the resolution in the in-track x-direction, which will be defined by the measurement sampling frequency.

Increasing the number of surface height measurements in one or both of the x- and y-directions improves the resolution of the surface height profile 260, enabling more accurate corrections, but it also increases the amount of time needed for the measurements. If the time to make the measure the surface height profile 260 becomes excessive, it may be desirable to use two different build platforms 68 so that a second part can be printed and transfused while the surface height profile 260 for the first part is being measured.

In some configurations, the surface profilometer 100 may be arranged to only provide surface height profile information for the most important portions of the 3D part 80 and support structure 82 (e.g., near edges of the 3D part 80), or to provide higher resolution surface height profile information in the most important portion. For example, the locations of one or more point sensors can be repositioned on a layer-by-layer basis based on the part geometry specified by the part and support structure shape data 205 (FIG. 5) in order to focus on the most important portions of each layer.

Returning to a discussion of FIG. 5, a control thickness for additional layers step 265 is next used to adjust one or more settings of the additive manufacturing system 10 (FIG. 1) in order to control the thickness profile of subsequently-printed part and support structure layers formed using the layer formation process 200 responsive to the measured surface height profile 260. In an exemplary embodiment, a control system 104 (FIG. 6) is used to analyze the measured surface height profile 260 and adjust one or more settings associated with the EP engines 12p, 12s (FIG. 2) to control the thickness profile of the subsequently-printed part and support structure layers. In some cases, the control system 104 can be the controller 36 (FIG. 1), or can be a component of the controller 36. In other cases, the control system 104 can be an independent data processing system.

The layer formation process 200 is repeated for each of the layers that make up the 3D part and support structure 270, with the surface height profile 260 being measured for each iteration and used to control the thickness of subsequent layers. After repeating the layer formation process 200 for all of the layers, the resulting 3D part and support structure 270 is removed from the additive manufacturing system 10 and post-printing operations can be used to remove the support structure 82, leaving the final 3D part 80.

In some configurations, the surface height profile 260 is analyzed to determine an overall height error by comparing an overall height of the transfused layers relative to an expected nominal height. The overall height of the transfused layers can be determined by measuring the surface height at an appropriate location, or more preferably can be determined by averaging the surface height determined at a plurality of locations across the surface of the transfused layers of the 3D part 80 and support structure 82. The overall layer thickness of subsequently printed layers can then be controlled in accordance with the determined overall height error. For example, if it is determined that the overall surface height is slightly lower (or higher) than the expected nominal height, then the layer thickness of one or more of the subsequently printed layers can be increased (or decreased) in order to compensate for the height error. Consider the case where the nominal layer thickness is 40 μm. After printing 10 layers, the expected surface height of the top layer would be 10×40 μm=400 μm. However, if analyzing the measured surface height profile 260 shows that the average surface height is 398 μm, then the EP engines 12p, 12s can be controlled to increase the layer thickness of one or more of the subsequent layers until the average surface height matches the expected surface height. For small surface height errors, it may be possible to fully correct the error in a single layer. For layer surface height errors it may take several layers before the error is fully corrected.

The layer thickness of the subsequently printed layers can be controlled in a variety of manners. In an exemplary configuration, the layer thickness can be controlled by adjusting appropriate parameters for one or more components of the EP engines 12p, 12s (FIG. 2). For example, the charge provided by the charging device 54 (FIG. 2) can be adjusted by controlling a charging voltage, the exposure provided by the imager 56 (FIG. 2) can be adjusted by controlling a light intensity provided by the light sources, or the amount of toner deposited by the development station 58 (FIG. 2) can be adjusted by controlling a bias voltage.

In some cases, overall height errors can be determined independently for the part material layer 64p and the support material layer 64s. The layer thicknesses of the subsequently-printed part material layers 64p and the support material layers 64s can then be independently adjusted by controlling parameters in the respective EP engines 12p, 12s, until the overall heights of the part material layer 64p and the support material layer 64s match each other, or until they both match the expected surface height.

It can be important to maintain the surface height of the transfused part material layers 64p and support material layers 64s at the same surface height. In some embodiments, the surface height profile 260 is analyzed to determine a height difference between the transfused part material layers 64p and support material layers 64s. The thickness profile for one or both of the subsequently-printed part material layers 64p and the support material layers 64s can then be adjusted to reduce the height difference.

In some cases, the surface height profile 260 is analyzed to determine a localized height errors in localized surface regions. In this way, non-uniformities in the surface height profile can be detected and corrected. For example, it might be determined that the surface height along the left edge is low, while the surface height along the right edge is high. In the limit, localized height errors can be determined for each image pixel. The localized thickness profile of one or more subsequently printed layers can then be controlled in accordance with the determined localized height errors. Certain control parameters are more appropriate for making localized thickness adjustments than others. For example, the exposure provided by the imager 56 (FIG. 2) can be adjusted by controlling the light intensity on a pixel-by-pixel basis to provide localized thickness adjustments as a function of position within the part material layer 64p and the support material layer 64s.

In some cases, the surface height profile 260 is analyzed to detect the presence of a printing artifact. Examples of such printing artifacts would include streak artifacts (i.e., “lines” extending in the x-direction), banding artifacts (i.e., “lines” extending in the y-direction), spot artifacts, and registration artifacts. For example, a streak artifact may be detected where the surface height is lower along the length of the streak artifact than in the surrounding portions of the surface. In this case, the localized thickness profile of one or more subsequently printed layers can then be controlled to compensate for the detected printing artifact by increasing the thickness of the corresponding positions in one or more subsequent layers.

In addition to controlling the parameters of the EP engines 12p, 12s discussed above, other aspects of the additive manufacturing system 10 can also be controlled responsive to the measured surface height profile 260. For example, the surface height profile 260 can be analyzed to detect registration errors between the actual x-y positions of the transfused part material layers 64p and support material layers 64s and their expected positions. In some configurations, the measured registration errors can be fed back into a registration control system associated with the EP engines 12p, 12s in order to reduce the registration errors for subsequently-printed part material layers 64p and support material layers 64s. In other configurations, the position of the build platform 68 can be controlled during the transfusing process to adjust the x-y position of the transfused layers.

For cases where a tiling scheme is used to produce large format parts, tiling artifacts can be caused at the tile boundaries. Such tiling artifacts can be detected by analyzing the surface height profile 260. The start position of the build platform 68 can then be adjusted for the tiles in subsequent layers in order to correct for the tiling artifacts.

In some configurations, the actual overall height of the transfused layers can be determined after each layer is printed. The thickness profile of the subsequently-printed part material layers 64p and support material layers 64s can be controlled by using the part and support structure shape data 205 to provide the appropriate shape data for the subsequent layers based on the shape of the part and support structure at the actual overall height (as opposed to the expected overall height). In this way, even if the layer thicknesses are off from the aim layer thickness by a small amount, the geometry of the final printed 3D part 80 can be preserved more accurately. This approach may result in printing the 3D part 80 using fewer or more layers than would be expected based on the nominal layer thickness.

In extreme cases where the detected printing artifacts are too large to be corrected by simply controlling the thickness of subsequently-printed layers, a number of different steps can be taken. In some cases, an operation can be applied to remove one or more of the previously printed layers (for example, by using a surface planing operation). The removed layers can then be reprinted. In other cases, the printing of the 3D part and support structure 270 can be terminated and the 3D part 80 can be discarded.

In the illustrated embodiments, the print material layers 64p and the support material layers 64s are printed using EP engines 12p and 12s. In other embodiments, other types of printing technologies such as ink jet printing can be used to form the print material layers 64p and the support material layers 64s.

The invention has been described in detail with particular reference to certain preferred embodiments thereof, but it will be understood that variations and modifications can be effected within the spirit and scope of the invention.

### PARTS LIST

10 additive manufacturing system
12p electrophotography (EP) engine
12s electrophotography (EP) engine
14 belt transfer assembly
16 biasing mechanism
18 biasing mechanism
20 layer transfusion assembly
22 transfer belt
22a front surface
22b rear surface
24 belt drive mechanism
26 belt drag mechanism
28 loop limit sensor
30 idler roller
32 belt cleaner
34 rotational direction
36 controller
38 host computer
40 frame
42 photoconductor drum
42a intermediary drum
44 conductive drum body
46 photoconductive surface
48 shaft
50 drive motor
50a drive motor
52 rotation direction
52a rotation direction
54 charging device
56 imager
58 development station
60 cleaning station
62 discharge device
64 combined layer
64p part material layer
64s support material layer
66p part material
66s support material
68 build platform
70 nip roller
72 heater
74 heater
76 post-fuse heater
78 air jets
80 3D part
82 support structure
84 gantry
86 motion pattern
88 motor
90 heating element
92 rotation direction
94 heating element
100 surface profilometer
102 probe
104 control system
200 layer formation process
205 part and support structure shape data
220 develop support structure layer step
225 develop part structure layer step
230 transfer support structure layer to transfer medium step
235 transfer part structure layer to transfer medium step
240 move transfer medium to layer transfusion assembly step
245 transfuse part and support structure layer to previous layers step
250 transfused part and support layer
255 measure surface height profile step
260 surface height profile
265 control thickness for additional layers step
270 3D part and support structure

1. A method for printing a three-dimensional part and with an electrophotography-based additive manufacturing system, the method comprising:
providing a part material compositionally including part material particles;
developing a part layer of the three-dimensional part from the part material with a first electrophotography engine;
transferring the developed part layer from the first electrophotography engine to a transfer medium;
transfusing the transferred part layer together to previously-printed layers using a layer transfusion assembly;
measuring a surface height profile of the transfused part layers using a surface profilometer; and
controlling a thickness profile of a subsequently-printed part layer responsive to the measured surface height profile.

2. The method of claim 1, further including analyzing the surface height profile to determine an overall height error by comparing an overall height of the transfused part layers relative to a nominal height, and wherein controlling the thickness profile of the subsequently-printed part layer includes controlling an overall layer thickness.

3. The method of claim 1, further including analyzing the surface height profile to determine a localized height error in a localized surface region, and wherein controlling the thickness profile of the subsequently-printed part layer includes adjusting a layer thickness in a portion of the three-dimensional part corresponding to the localized surface region responsive to the determined localized height error.

4. The method of claim 1, further including analyzing the surface height profile to detect localized height errors associated with the presence of a printing artifact, and wherein controlling the thickness profile of the subsequently-printed part layer includes adjusting a layer thickness in a portion of the three-dimensional part corresponding to the printing artifact responsive to the determined localized height error.

5. The method of claim 4, wherein the printing artifact is a streak artifact, a banding artifact or a spot artifact.

6. The method of claim 4, wherein the printing artifact is a registration artifact, and further including adjusting the registration of the subsequently-printed part layer.

7. The method of claim 1, wherein the surface profilometer is a non-contact device.

8. The method of claim 7, wherein the non-contact device is an optical device.

9. The method of claim 8, wherein the optical device includes a radiation-emitting element that directs a beam of radiation onto a surface of the transfused part layer and a detector which senses a surface height based on detecting radiation reflected from the surface of the transfused part layer.

10. The method of claim 7, wherein the non-contact device is an ultrasonic sensing device that includes an ultrasonic source that directs ultrasonic waves onto the surface of the transfused part layer and a detector which senses a surface height based on detecting ultrasonic waves reflected from the surface of the transfused part layer.

11. The method of claim 7, wherein the surface profilometer is a contact device including a mechanical probe that contacts the surface of the transfused part layer.

12. The method of claim 11, wherein the surface profilometer determines a position of the mechanical probe using a linear variable differential transformer.

13. The method of claim 1, wherein a position of the surface profilometer is adjusted in accordance with data specifying the shape of the three-dimensional part.

14. The method of claim 1, further including building a support structure together with the three-dimensional part by:
providing a removable support material compositionally including support material particles;
developing a support layer of the support structure from the support material with a second electrophotography engine; and
transferring the developed support layer from the second electrophotography engine to the transfer medium;
wherein the transfusing step includes transfusing the transferred support layer together to the previously-printed layers using the layer transfusion assembly, and wherein the measuring the surface height profile step includes measuring a surface height profile of the transfused support layers.

15. The method of claim 14, further including controlling a thickness profile of a subsequently-printed support layer responsive to the measured surface height profile.

16. The method of claim 15, wherein the thickness profile of the subsequently-printed support layer is controlled to reduce differences between the surface heights of the transfused part layers and the surface heights of the transfused support layer.

17. A method for printing a three-dimensional part and with an additive manufacturing system, the method comprising:
providing a part material compositionally including part material particles;
printing a part layer of the three-dimensional part onto a transfer medium by applying the part material with a first printing engine;
transfusing the printed part layer together to previously-printed layers using a layer transfusion assembly;
measuring a surface height profile of the transfused part layers using a surface profilometer; and
controlling a thickness profile of a subsequently-printed part layer responsive to the measured surface height profile.
